(19) United States
(12) Patent Application Publication
(10) Pub. No.: US 2016/0239933 A1
(43) Pub. Date: Aug. 18, 2016

(54) AIRPORT AUTOMATIC REMINDER SYSTEM AND METHOD THEREFOR

(71) Applicant: Chiun Mai Communication Systems, Inc., New Taipei (TW)

(72) Inventors: CHENG-KUO YANG, New Taipei (TW); YIN-HSUAN CHIEN, New Taipei (TW); YI-JEN HUANG, New Taipei (TW); HAO SUN, New Taipei (TW)

(21) Appl. No.: 15/012,856

(22) Filed: Feb. 2, 2016

Related U.S. Application Data
(60) Provisional application No. 62/115,160, filed on Feb. 12, 2015.

(51) Int. Cl. G06Q 50/30; G06Q 10/02; H04W 4/00; G01C 21/20

(52) U.S. Cl. CPC G06Q 50/30; G01C 21/206; G06Q 10/02; H04W 4/008

(57) ABSTRACT

In an airport automatic reminder method, an airport automatic reminder server receives passenger information from a wearable device via a plurality of base stations, receives flight information from an airport flight server, and transmits the flight information and other information corresponding to the passenger information to the wearable device for display.

### CROSS-REFERENCE TO RELATED APPLICATIONS

This application is a non-provisional application of U.S. provisional application Ser. No. 62/115,160, filed Feb. 12, 2015.

### FIELD

The subject matter herein generally relates to a communication system. More particularly, the present application relates to an airport automatic reminder system and method therefor.

### BACKGROUND

When at an airport, a passenger may need to go to an electronic information board frequently to check flight information such as a boarding gate, boarding time, and airport terminal. An airport environment may be unfamiliar to the passenger, thus, it is possible the flight will be missed if the passenger does not do everything correctly and on time.

Most airports are large. For providing a comfortable environment for passengers, the airports may include a lot of convenience facilities. However, when arriving at an airport, due to unfamiliarity with the airport environment, the passengers have no effective navigation to acquire definite information about stores locations, merchandise discounts, and leisure space may be absent, thus the passengers sometimes cannot use the facilities as they expect.

Smartphones can be used for indoor navigation via mobile communication services, WI-FI or BEACON; however, not all large indoor places provide a user-friendly communication environment. Especially, airport is unfamiliar for most of people, even if particular application software can be provided for people to acquire information about flight, commodity, and indoor navigation, it may happen that people forget to apply for roaming service in foreign airport, thus, expensive cost for streaming data may be a trouble.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows system architecture of one embodiment of an airport automatic reminder system.

FIG. 2 shows hardware architecture of a wearable device of the airport automatic reminder system of FIG. 1.

FIG. 3 is a flowchart of one embodiment of an airport automatic reminder method.

### DETAILED DESCRIPTION

It will be appreciated that for simplicity and clarity of illustration, where appropriate, reference numerals have been repeated among the different figures to indicate corresponding or analogous elements. In addition, numerous specific details are given in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

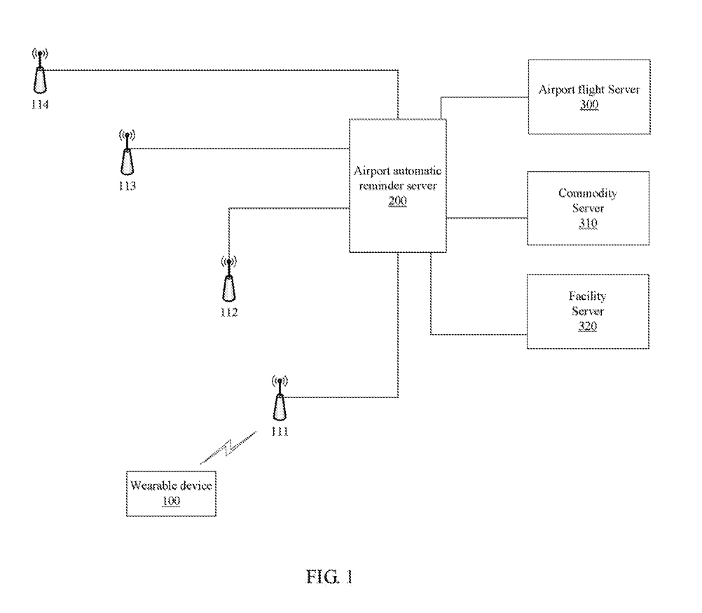

FIGS. 1-3 show respectively system architecture, wearable device architecture, and a method flowchart of embodiments of the airport automatic reminder system of the present disclosure. The embodiments are illustrative only. It will therefore be appreciated that the present disclosure is not limited by embodiments herein.

As illustrated in FIG. 1, the airport automatic reminder system includes a wearable device 100, a plurality of BLUETOOTH base stations 111-114, an airport automatic reminder server 200, an airport flight server 300, at least one commodity server 310, and at least one facility server 320. The airport automatic reminder server 200 can connect to the plurality of BLUETOOTH base stations 111-114. Furthermore, the airport automatic reminder server 200 can connect to the airport flight server 300, the at least one commodity server 310, and the at least one facility server 320 through a wired network. The airport automatic reminder server 200 can receive relative location information sent by the wearable device 100 via the plurality of BLUETOOTH base stations 111-114, receive flight information such as a flight schedule, arrival time and takeoff time from the airport flight server 300, and receive a commodity list of the airport from the at least one commodity server 310. The airport automatic reminder server 200 can also receive store information, store location information, hotel information, and other information concerning the airport, from the at least one facility server 320.

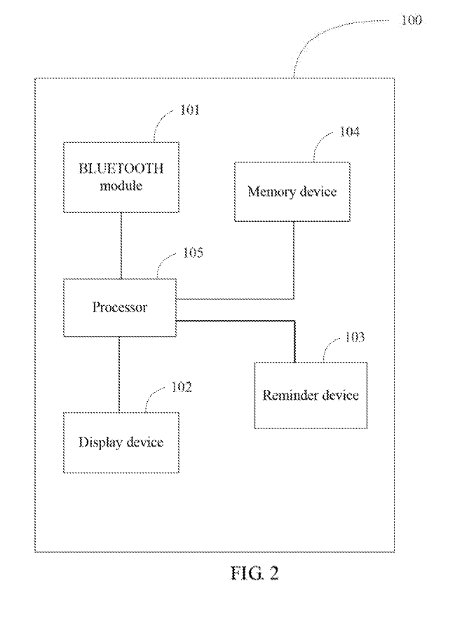

FIG. 2 illustrates the wearable device 100 of one embodiment of the airport automatic reminder system. The wearable device 100 includes a BLUETOOTH module 101, a display device 102, a reminder device 103, a memory device 104, a processor 105, and a fixture (not shown).

The display device 102 displays information to passengers. The display device 102 is located on front surface, top portion, or other visible portion of the wearable device 100, which is convenient for the passengers to read information. The display device 102 can be a liquid crystal display (LCD), a light emitting diode (LED) display, or any other suitable electronic display screen.

The BLUETOOTH module 101 connects to the plurality of BLUETOOTH base stations 111-114 and transmits related BLUETOOTH parameters. In one embodiment, the BLUETOOTH module 101 establishes connections with the plurality of BLUETOOTH base stations 111-114 and obtains information indicating signal strengths of three adjacent BLUETOOTH base stations 111-114. The wearable device 1 compares the signal strengths of the three adjacent BLUETOOTH base stations; for example, if the signal strength of the BLUETOOTH base station 111 is strongest, it can be determined that the wearable device 100 is closest to this BLUETOOTH base station 111. The BLUETOOTH base stations 111-114 are fixed in predetermined locations in the airport. The wearable device 100 obtains the information of signal strengths and transmits the information of the signal strengths and ID of the wearable device 100 to the airport automatic reminder server 200 through the BLUETOOTH module 101. The airport automatic reminder server 200 can compute relative location information of the wearable device 100 according to the received information.

In one embodiment, when the wearable device 100 is activated, namely a BLUETOOTH function is activated, the wearable device 100 outputs a reminder on the display device 102 to request a passenger to input passenger information. In other embodiment, when a passenger checks in at an airline service center, service staff may input passenger information using a computing device. The computing device then transmits the passenger information to the wearable device 100 wirelessly. The passenger information can include name, gender, age, passport number, ticket information, flight information, and commodity types and facilities of interest in the airport.

When the passenger activates the wearable device 100, the BLUETOOTH module 101 is activated. The wearable device 100 transmits the passenger information to the plurality of BLUETOOTH base stations 111-114 using the BLUETOOTH module 101 and further transmits the passenger information to the airport automatic reminder server 200 through one of the BLUETOOTH base stations 111-114. The airport automatic reminder server 200 performs computations according to IDs of the BLUETOOTH base stations 111-114 and an ID of the wearable device 100 and obtains information, such as remaining time before boarding, distance to a boarding gate and so on, based on the computations for different predetermined functions.

The BLUETOOTH module 101 in the present application can be replaced by other wireless transmission module, such as RFID, WI-FI, ZIGBEE, infrared or any other wireless technology of which signal strength as a function of distance can be determined, for indoor positioning.

The reminder device 103 reminds the passenger to check or confirm information displayed on the display device 102 of the wearable device 100, or information audibly given by the reminder device 103. In one embodiment, the reminder device 103 can be a speaker and play the information, or generate an audible warning sound for reminding the passenger. In another embodiment, the reminder device 103 can be a vibration element located inside of the wearable device 100 and generate vibration to reminder the passenger of the wearable device 100 to check or confirm information displayed on the display device 102 of the wearable device 100. In another embodiment, the reminder device 130 may be an LED indicator. When displayable information is received, the LED indicator generates and emits color light to remind the passenger of the received information.

The memory device 104 stores information transmitted to the wearable device from the BLUETOOTH base stations 111-114, the airport automatic reminder server 200, the airport flight server 300, the at least one commodity server 310 and the at least one facility server 320. The information may be a flight schedule, arrival time, takeoff time, a commodity list, store information, store location information, hotel information, a remaining time before boarding, distance to a boarding gate, and so on. The information may include local geography, picture, explanatory note, or audio guide, etc. The memory device 104 can be disposed inside the wearable device 100 and connects to the BLUETOOTH module 101, the display device 102 and the reminder device 103. The memory device 104 can be a flash memory, an SD card, a Micro SD card or a Nano SD card.

The processor 15 connects to BLUETOOTH module 101, the display device 102, the reminder device 103 and the memory device 104. The processor 105 can processes information received from the airport automatic reminder server 200 via the plurality of BLUETOOTH base stations 111-114. For example, the processor 105 can store the information in the memory device 104, and then control the display device 102 to display the information or control the reminder device 103 to generate a reminder message. The reminder device 103 can be a speaker to play the information or generate a warning sound for reminding the passenger, can be a vibration element located inside the wearable device 100 to generate vibration to reminder the passenger of the wearable device 100 to check or confirm information displayed on the display device 102, or can be a LED indicator to emit color light to remind the passenger of any received information.

The fixture is an element for fixing the wearable device 100 on the body of the passenger and enables the passenger to fix the wearable device 100 on his wrist or attach the wearable device 100 to carryon luggage, so that the passenger can easily confirm the information in time.

The airport automatic reminder server 200 connects to the plurality of BLUETOOTH base stations 111-114, the airport flight server 300, the at least one commodity server 310, and the at least one facility server 320. The airport automatic reminder server 200 receives relative location information of the wearable device 100 through the plurality of BLUETOOTH base stations 111-114, receives the flight information such as flight schedule, arrival time and takeoff time from the airport flight server 300, receives a commodity list of the airport from the at least one commodity server 310, and receives store information, store location information, hotel information, etc., from the at least one facility server 320. The airport automatic reminder server 200 can compute information including amount of remaining time before boarding and a distance to a boarding gate.

The airport flight server 300 stores flight information such as a flight schedule, arrival time and takeoff time. With the flight information provided by the airport flight server 300, a passenger has no need to check the electronic information board to get important information and can know a remaining time A before boarding and a required time B to walk to a boarding gate by using the wearable device 100 connected to a wireless network.

The at least one commodity server 310 stores commodity information such as price and goods information, discount information, and popular commodity information etc., in the stores of the airport. In the present embodiment, a map of the airport is stored, together with commodity information in the airport, duty free commodities, prices of the duty free commodities, and popular commodities, into the at least one commodity server 310. The passenger can investigate the commodity information via wireless network.

The at least one facility server 320 stores basic information of facilities in the airport, availability of the facilities, prices, locations of the facilities, and so on.

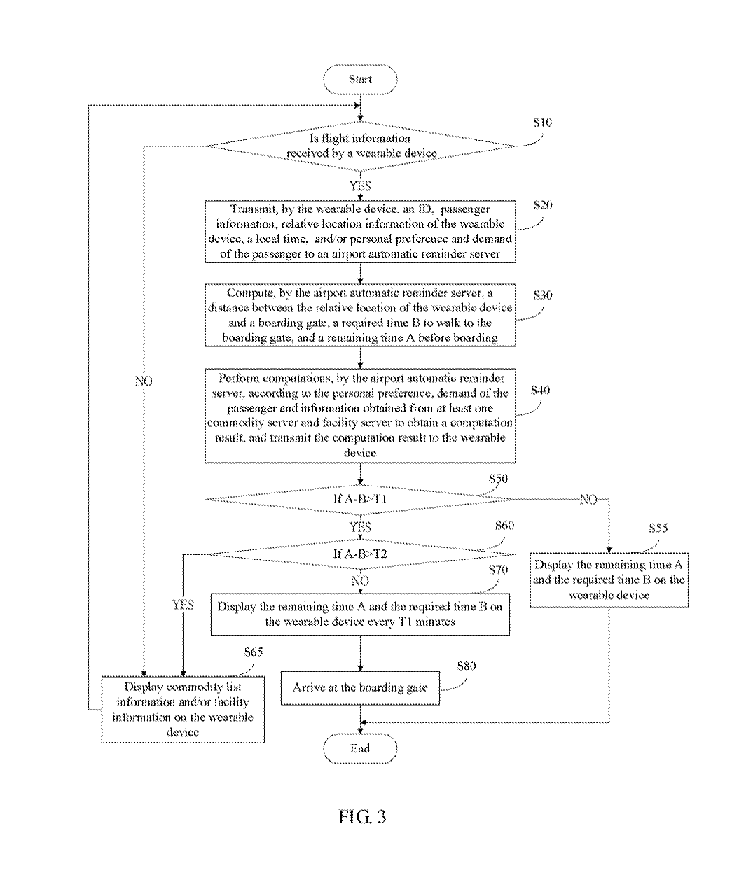

Referring to FIG. 3, a flowchart of one embodiment of an airport automatic reminder method is illustrated with referring to the system architecture in FIG. 1.

At block S10, the wearable device 100 determines if flight information is received from the airport flight server 300. When flight information is received from the airport flight server 300, block S20 is implemented. When no flight information is received from the airport flight server 300, block S65 is implemented.

At block S20, the wearable device 100 transmits an ID of the wearable device 200, passenger information of the wearable device 200, relative location information of the wearable device 100 obtained using the plurality of BLUETOOTH base stations 111-114, and personal preference and demand of the passenger, to the airport automatic reminder server 200.

At block S30, the airport automatic reminder server 200 computes a distance between the relative location of the wearable device 100 and a boarding gate, computes a required time B to walk to the boarding gate according to the distance and a walking velocity, and further computes a remaining time A before boarding according to flight information transmitted from the airport flight server 300. The airport automatic reminder server 200 transmits the time A and the time B to the wearable device 100.

At block S40, the airport automatic reminder server 200 connects to the at least one commodity server 310 and the at least one facility server 320, performs computations according to the personal preference, demand of the passenger and the information obtained from the at least one commodity server 310 and the at least one facility server 320 so as to obtain a computation result, stores the computation result into the airport automatic reminder server 200, and further transmits the computation result to the wearable device 100 via the plurality of BLUETOOTH base stations 111-114.

At block S50, the wearable device 100 determines if the difference between the remaining time A before boarding and the required time B to walk to the boarding gate is greater than a first predetermined value T1, namely if A-B>T1. When A-B>T1, block S60 is implemented. When A-B≦T1, block S55 is implemented. In one embodiment, the predetermined value T1 can be 15 minutes, or any other value. When A-B≦T1, the passenger need to go to the boarding gate immediately, and no other things can be done. If the passenger does other things, his flight may be missed.

At block S55, the wearable device 100 displays the remaining time A and the required time B on the display device 102.

Block S60, the wearable device 100 further determines if the difference between the remaining time A before boarding and the required time B to walk to the boarding gate is greater than a second predetermined value T2, namely if A-B>T2. When A-B>T2, block S65 is implemented. When A-B≦T2, block S70 is implemented. In one embodiment, the predetermined value T2 can be 30 minutes, or any other value. When A-B>T2, the passenger does not need to go to the boarding gate immediately. At this time, even if other thing is done, the passenger does not miss his flight.

At block S65, the airport automatic reminder server 200 transmits the computation result of block S40 to the wearable device 100, and the wearable device 100 displays commodity list information and/or facility information included in the computation result, which is computed according to the personal preference and demand of the passenger, on display device 102.

At block S70, the wearable device 100 displays the remaining time A and the required time B on the display device 102 of the wearable device 100 every a time interval, for example every T1 minutes.

At block S80, the wearable device 100 determines the passenger has arrived at the boarding gate according to the signal strengths of the plurality of BLUETOOTH base stations 111-114 and displays an arrived message on the display device 102.

The airport automatic reminder 200 can push commodity information and facility information in an adjacent area according to the relative location information of the passenger and the personal preference and demand of the passenger.

The present application combines the wearable device 100 with the flight information, the commodity information, and the facility information obtained from the airport automatic reminder server 200, the airport flight server 300, the at least one commodity server 310, and the at least one facility server 320. According to the relative location information of the passenger of the wearable device 100, the airport automatic reminder server 200 pushes the flight information and surrounding environment information to the wearable device 100. Thus, events of missing flights can be reduced and good experiences in the airport can be increased. Using the present application, problems that passengers may face originally in the airport can be solved.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An airport automatic reminder system, comprising:
a wearable device;
a plurality of base stations; and
an airport automatic reminder server; wherein:
the airport automatic reminder server is configured to connect to the plurality of base stations, and receive passenger information from the wearable device via one of the base station and send flight information to the wearable device according to the passenger information via the one or another one of the base stations.

2. The airport automatic reminder system according to claim 1, further comprising:
an airport flight server configured to store the flight information, which comprises at least one of a flight schedule, arrival time and takeoff time, and
to transmit the flight information to the airport automatic reminder server.

3. The airport automatic reminder system according to claim 1, further comprising:
at least one commodity server configured to store commodity information of stores, which comprises at least one of price information, discount information, popular commodity information, and to transmit the commodity information to the airport automatic reminder server;
wherein the airport automatic reminder server is further configured to receive the commodity information and transmit the commodity information to the wearable device.

4. The airport automatic reminder system according to claim 1, further comprising:
at least one facility server configured to store facility information of the airport, which comprises at least one of usage rates of facilities, prices of the facilities, and locations of the facilities, and to transmit the facility information to the airport automatic reminder server;
wherein the airport automatic reminder server is further configured to receive the facility information and transmit the facility information to the wearable device.

5. The airport automatic reminder system according to claim 1, wherein the airport automatic reminder server is further configured to compute at least one of a remaining time before boarding and a required time to walk to a boarding gate according to a relative location information of the wearable device, and transmit the at least one of the remaining time and the required time to the wearable device.

6. The airport automatic reminder system according to claim 5, wherein the wearable device is configured to establish connections with the plurality of base stations, obtain information indicating signal strengths of the base stations, and transmit the information indicating signal strengths to the airport automatic reminder server to compute the relative location information of the wearable device.

7. The airport automatic reminder system according to claim 1, wherein the wearable device comprises a display device and a reminder device, wherein:
the display device is configured to display information to a passenger; and
the reminder device is configured to generate an audible sound, vibration or light to remind the passenger to check or confirm the information displayed on the display device.

8. The airport automatic reminder system according to claim 7, wherein the reminder device is a speaker for generating the audible sound, a vibration element for generating the vibration, or an LED indicator for generating the light.

9. An airport automatic reminder method, comprising:
receiving, by an airport automatic reminder server, passenger information from a wearable device via at least one of a plurality of base stations;
receiving, by the airport automatic reminder server, flight information from an airport flight server; and
transmitting, by the airport automatic reminder server, the flight information to the wearable device according to the passenger information via the at least one of the plurality of base stations.

10. The airport automatic reminder method according to claim 9, further comprising:
receiving, by the airport automatic reminder server, commodity information from at least one commodity server, wherein the commodity information comprises at least one of price and goods information, discount information and popular commodity information; and
transmitting, by the airport automatic reminder server, the commodity information to the wearable device.

11. The airport automatic reminder method according to claim 10, further comprising:
computing, by the airport automatic reminder server, at least one of a remaining time A before boarding and a required time B to walk to a boarding gate according to a relative location information of the wearable device, and transmitting the at least one of the remaining time A and the required time B to the wearable device;
displaying, by the wearable device, the at least one of the remaining time A and the required time B when A-B≦T1, wherein T1 is a first predetermined value; and
transmitting, by the airport automatic reminder server, the commodity information to the wearable device when A-B>T2, wherein T2 is a second predetermined value and T2>T1.

12. The airport automatic reminder method according to claim 9, further comprising:
establishing, by the wearable device, connections with the plurality of base stations;
obtaining, by the wearable device, information indicating signal strengths of the base stations;
transmitting, by the wearable device, the information indicating signal strengths to the airport automatic reminder server; and
computing, by the airport automatic reminder server, a relative location information of the wearable device according to the signal strengths.

13. The airport automatic reminder method according to claim 12, further comprising:
determining the passenger has arrived at the boarding gate according to the signal strengths of the plurality of base stations, and displaying an arrived message on the wearable device.

14. The airport automatic reminder method according to claim 9, further comprising:
receiving, by the airport automatic reminder server, facility information from at least one facility server, wherein the facility information comprises at least one of availability of the facilities, prices of the facilities, and locations of the facilities; and
transmitting, by the airport automatic reminder server, the facility information to the wearable device.

15. The airport automatic reminder method according to claim 14, further comprising:
computing, by the airport automatic reminder server, at least one of a remaining time A before boarding and a required time B to walk to a boarding gate according to a relative location information of the wearable device, and transmitting the at least one of the remaining time A and the required time B to the wearable device;
displaying, by the wearable device, the at least one of the remaining time A and the required time B when A-B≦T1, wherein T1 is a first predetermined value; and
transmitting, by the airport automatic reminder server, the facility information to the wearable device when A-B>T2, wherein T2 is a second predetermined value and T2>T1.

16. A wearable device, comprising:
a communication module;
a display device;
a reminder device;
a memory device; and
a processor electrically connected to the communication module, the display device, the reminder device and the memory device; wherein:
the communication module is configured to connect to a plurality of base stations, and transmit information to and receive information from an airport automatic reminder server via the plurality of base stations;
the display device is configured to display the information received from the airport automatic reminder server;
the reminder device is configured to generate an audible sound, vibration or light to remind a passenger to check or confirm the information displayed on the display device; and
the memory device is configured to store the information sent to or the information received from the airport automatic reminder server.

17. The wearable device according to claim 16, wherein the communication module is one of a BLUETOOTH module, a RFID module, a Wi-Fi module, a Zigbee module, and an infrared module.

18. The wearable device according to claim 16, wherein the reminder device is a speaker, a vibration element or an LED indicator.

19. The wearable device according to claim 16, wherein the wearable device further comprises a fixture configured to fix the wearable device on the passenger or attach the wearable device to carryon luggage.
